(19) United States
(12) Patent Application Publication
(10) Pub. No.: US 2003/0118097 A1
(43) Pub. Date: Jun. 26, 2003

(54) System for realization of complexity scalability in a layered video coding framework

(75) Inventors: Richard Y. Chen, Croton on Hudson, NY (US); Mihaela Schaar, Ossining, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/028,386

(22) Filed: Dec. 21, 2001

(51) Int. Cl. H04N 7/12

(52) U.S. Cl. 375/240.2; 375/240.18; 375/240.08

(57) ABSTRACT

An encoder and decoder system for realization of complexity scalability in a layered video-coding framework. The layered video encoder comprises a base layer encoder for receiving a video signal and outputting a base layer stream; and an enhancement layer encoder that includes a plurality of discrete cosine transform (DCT) modules and a selection system for selecting one of the DCT modules. The layered video decoding system comprises a base layer decoder for receiving and decoding a base layer video stream; and an enhancement layer decoder for receiving an enhancement layer video stream and the decoded base layer stream, and generating a decoded enhanced video output, wherein the enhancement layer decoder includes: a plurality of inverse discrete cosine transform (IDCT) modules; and a selection system for selecting one of the IDCT modules.

### BACKGROUND OF THE INVENTION

1. Technical Field

The present invention relates generally to realization of complexity scalability in video encoder and decoder systems, and more particularly relates to a system and method for realization of complexity scalability in enhancement layer processing in encoder and decoder systems implementing a layered video coding framework, such as Fine-Granularity-Scalability (FGS) technology.

2. Related Art

In video coding systems such as MPEG-2, MPEG-4, etc., discrete cosine transform (DCT) and inverse discrete cosine transform (IDCT) operations are critical for coding quality. Unfortunately, these operations add significant computational complexity and cost to the encoding and decoding of video data. The computational expense results in significant constraints for real-time video compression/transmission applications employed over a wired or wireless network.

In motion estimation-based video frameworks (i.e., MPEGs), one forward DCT and one IDCT are embedded in the motion estimation loop of the encoder. As noted, the precision of the DCT, which has been standardized in IEEE 1180-1990, is critical to coding efficiency. On the decoder side, the IDCT must have the same precision to maintain decoding quality. Any mismatch between the precision of the DCT and HDCT will cause drifting that results in significant degradation of the overall video quality.

Given these precision requirements, it has been difficult to provide encoder and decoder systems that allow DCT and IDCT operations to be scaled to meet the computational requirements of the respective systems. However, in layered video coding frameworks, such as the Fine-Granularity-Scalability (FGS) coding profile in MPEG-4, video sequences are coded into two bit streams: the base layer (BL) video stream and the enhancement layer (EL) video stream. In FGS, only the BL is coded using a non-scalable coding scheme that employs a motion-estimation coding scheme. The EL, which codes the difference between the original and the BL signals in the DCT-domain using bit-plane coding, does not use motion-estimation coding. Accordingly, opportunities for scaling DCT and IDCT operations in layered video coding systems exist.

### SUMMARY OF THE INVENTION

The present invention addresses the above-mentioned issues, as well as others, by providing complexity scalable enhancement layer processing having multiple precision DCTs/IDCTs. In a first aspect, the invention provides a layered video encoding system, comprising: a base layer encoder for receiving a video signal and outputting a base layer stream; and an enhancement layer encoder that includes a plurality of discrete cosine transform (DCT) modules and a selection system for selecting one of the DCT modules.

In a second aspect, the invention provides a program product stored on a recordable medium for encoding a layered video signal, the program product comprising: means for receiving a video signal and outputting an encoded base layer stream; and means for encoding an enhancement layer, wherein the enhancement layer encoding means includes a plurality of discrete cosine transform (DCT) modules and selection means for selecting one of the DCT modules.

In a third aspect, the invention provides a method of encoding a video signal in a layered manner, comprising: receiving the video signal in a base layer encoding system; outputting an encoded base layer stream; receiving data from the base layer encoding system into an enhancement layer encoding system; providing a plurality discrete cosine transform (DCT) modules in the enhancement layer encoding system; selecting one of the plurality of DCT modules; and generating an encoded enhancement layer stream using the selected DCT module.

In a fourth aspect, the invention provides a layered video decoding system, comprising: a base layer decoder for receiving and decoding a base layer video stream; and an enhancement layer decoder for receiving an enhancement layer video stream and generating a decoded enhanced video output, wherein the enhancement layer decoder includes: a plurality of inverse discrete cosine transform (IDCT) modules; and a selection system for selecting one of the IDCT modules.

In a fifth aspect, the invention provides a program product stored on a recordable medium for decoding a layered video stream, comprising: means for receiving and decoding a base layer video stream; and means for receiving an enhancement layer video stream and generating a decoded enhanced video output, including: a plurality of inverse discrete cosine transform (IDCT) modules; and means for selecting one of the IDCT modules.

In a sixth aspect, the invention provides a method of decoding a layered video stream, comprising: receiving an encoded base layer stream into a base layer decoder; decoding the encoded base layer stream and generating a decoded base layer stream; providing an enhancement layer decoder having a plurality of inverse discrete cosine transform (IDCT) modules; receiving an encoded enhancement layer stream into the enhancement layer decoder; selecting one of the plurality of IDCT modules; and decoding the encoded enhancement layer using the selected IDCT module.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a known art FGS encoder.

FIG. 2 depicts an FGS encoder having multiple precision DCT's in accordance with an embodiment of the present invention.

FIG. 3 depicts a known art FGS decoder.

FIG. 4 depicts an FGS decoder having multiple precision IDCT's in accordance with an embodiment of the present invention.

FIG. 5 depicts a graph showing rate distortion versus complexity.

### DETAILED DESCRIPTION OF THE INVENTION

For the purposes of this description, the following embodiments are described with reference to an SNR (signal-noise-ratio)-FGS MPEG4 video-coding framework. However, it is understood that the invention can be applied to any layered video coding framework in which the enhancement layer does not have a motion-estimation loop. Examples include MJPEG, as well as most SNR-scalable frameworks. It is expected that the principles and concepts of an SNR-FGS system are known to one skilled in the art, and therefore such details are not described herein.

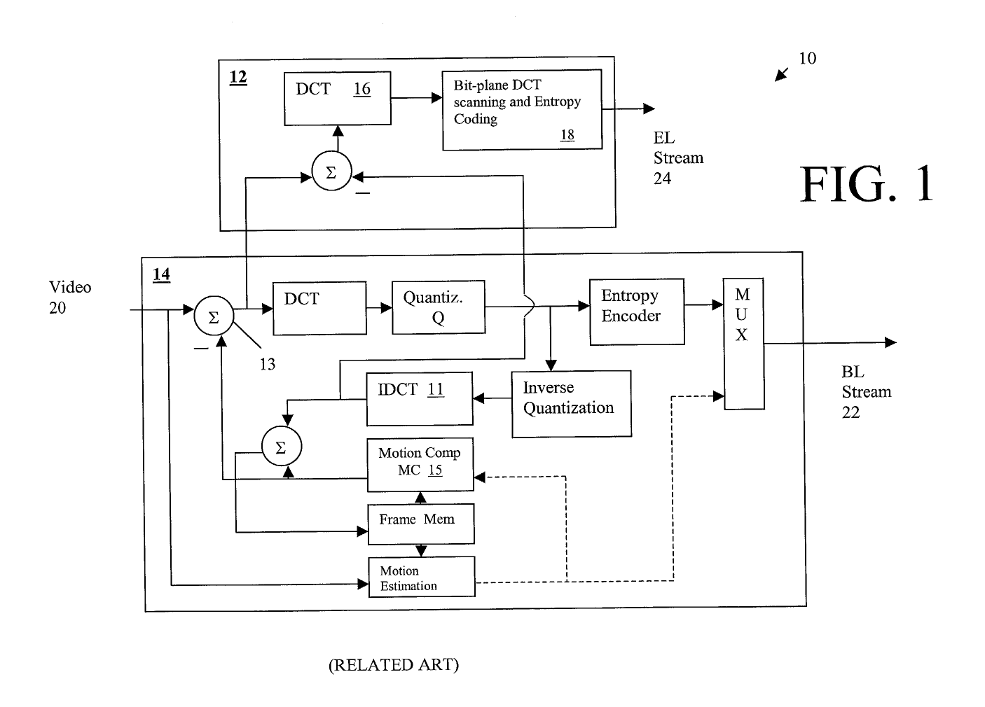

Referring now the figures, FIG. 1 is a diagram of a state of the art FGS encoder 10. FGS encoder 10 includes a base layer encoder 14 and an enhancement layer encoder 12. Base layer encoder 14 receives a video input 20 and outputs a base layer (BL) stream 22. Enhancement layer encoder 12 generates an enhancement layer (EL) stream 24 using a DCT 16 and a bit-plane DCT scanning and entropy coding system 18. Enhancement layer encoder 12 receives data from various components of the base layer encoder, including IDCT 11 and summer 13, which calculates a difference between the video input 20 and motion compensation 15.

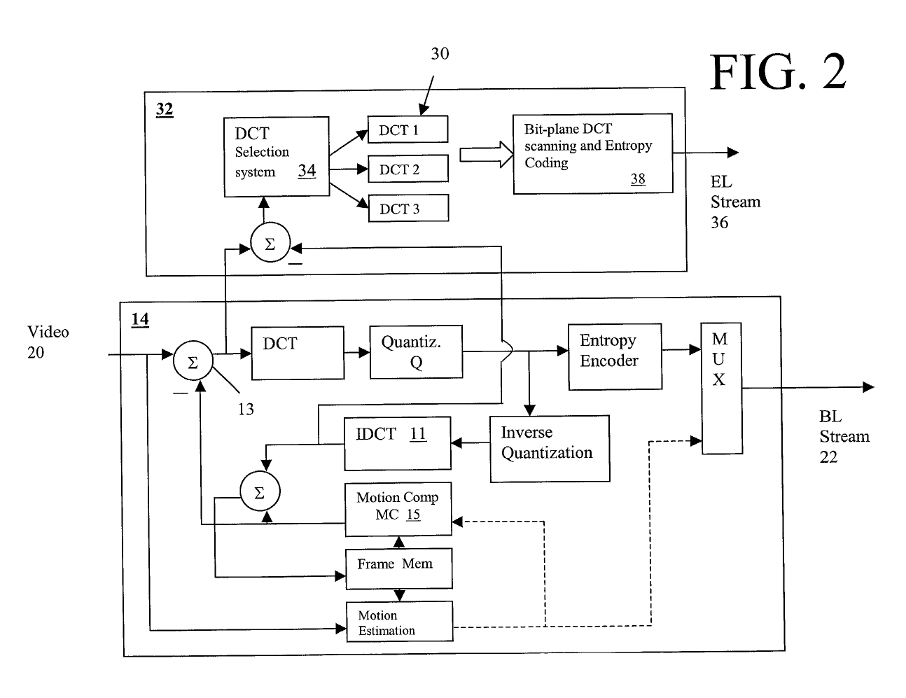

Referring now to FIG. 2, an improved FGS encoder is shown. The improved encoder, which may include the same BL encoder 14 as above, has a plurality of varying precision DCT's 30 (i.e., multi-precision DCT's) in the enhancement layer encoder 32. Also included in the EL encoder 32 is a DCT selection system 34 that includes a decision-making mechanism for choosing the appropriate DCT based on, for example, information regarding the instantaneous computing resources of the encoder. In general, the greater the DCT precision, the more computing resource required to encode the enhancement layer. Selecting the appropriate DCT can be based on any relevant criteria, including: the encoding bit rate, available bandwidth, desired quality (i.e., SNR), decoder capability, etc.

An example of a system where it may be useful to have selectable DCT's in enhancement layer encoding is as follows. When an encoder is broadcasting to a group of users using phone lines, the maximum available bandwidth is known beforehand. Accordingly, it would be wasteful to send an enhancement layer at a rate greater than the maximum bandwidth. In this scenario, it does not make sense to use the same high precision DCT as used in the base layer to code the enhancement layer since the bit planes will be significantly truncated to meet the bandwidth availability. Thus, in this case, a lower precision DCT can be used to achieve lower computing complexity without causing additional distortion. Furthermore, by using a lower precision DCT, both the encoding at the sender site and decoding at the receiver site can run faster to achieve a higher frame rate.

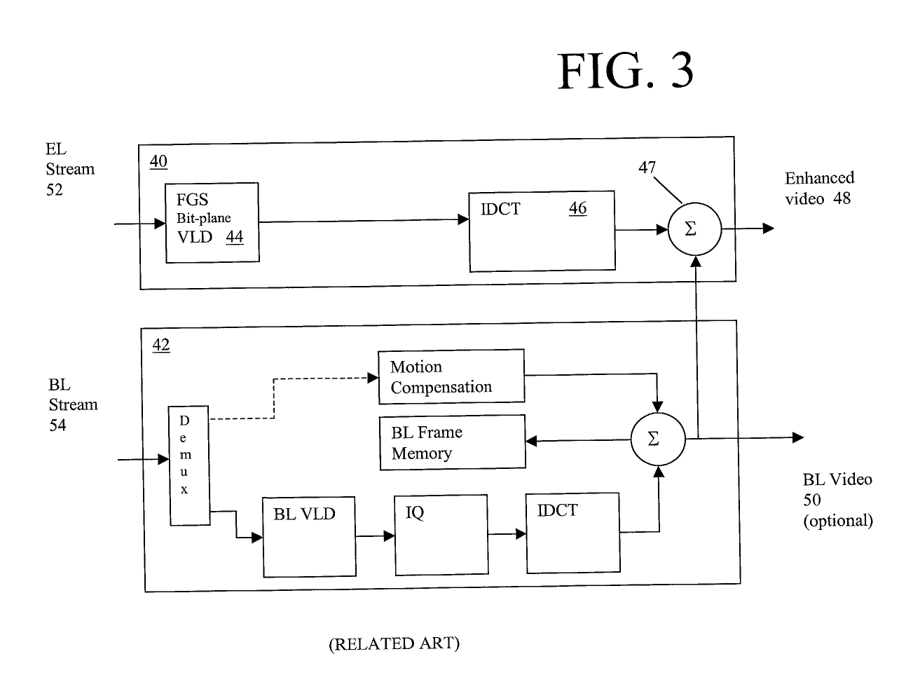

Referring now to FIG. 3, a state of the art FGS decoder is shown that receives an EL stream 52 and a BL stream 54, and outputs an enhanced video 48 (as well as an optional BL video output 50). The state of the art FGS decoder includes a BL decoder 42, and an EL decoder 40. EL decoder 40 comprises an FGS bit-plane VLD 44, an IDCT 46, and a summer 47 for summing the output of the IDCT 46 and the BL video output 50.

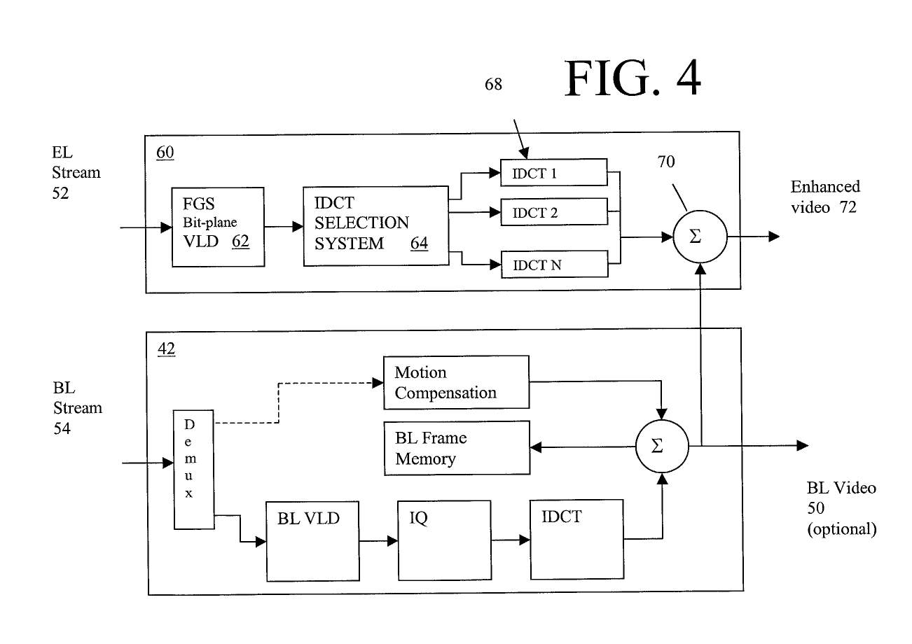

FIG. 4 depicts a novel FGS decoder in accordance with the present invention. The novel decoder, which may include the same BL decoder 42 as shown above, has a plurality of IDCT's 68 of varying precision (i.e., multi-precision IDCT's) in the EL decoder 60. Also included is an IDCT selection system 64 that includes a decision-making mechanism for selecting the appropriate IDCT based on any relevant criteria. Such criteria may include available computing resources, quality requirements, frame rate preference, preferred bit rate, communication bandwidth, etc. Thus, even if the encoder sends a high quality enhancement layer, the present decoder has the freedom to use a lower precision IDCT based on the constraints presented to the decoder.

Thus, consider the case where a user is using a mobile device to see a video of the person at the sending site. Such devices typically can be expected to have limited computing power. However, because the screen is relatively small, high quality video may not be required. Moreover, with this type of application, a higher frame rate is generally preferable to avoid jitter. Accordingly, in this case, the decoder on the mobile device could truncate the enhancement layer and use a lower precision IDCT to decode the truncated enhancement layer to reduce complexity and achieve a higher frame rate.

In the case of video conferencing, the video device has to simultaneously perform encoding and decoding, so that both parties can receive video signals. Since the complexity of the encoder is usually many times higher than that of the decoder, the computing resources available for the decoder may be significantly reduced, and the graceful downscaling of computing complexity is extremely necessary. By utilizing a lower precision IDCT, graceful downscaling can be achieved.

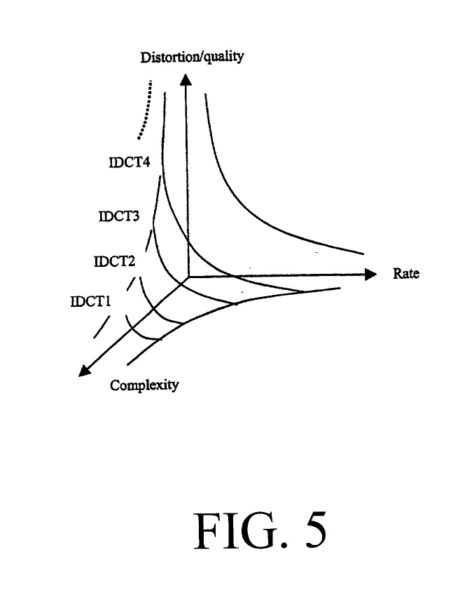

Referring to FIG. 5, a graph is depicted showing the relationship between rate distortion characteristics and computing complexity of an exemplary set of IDCT's 68 (IDCT1-IDCT 4).

In a layered video-coding framework, the base layer is typically coded at a very low bit rate. As such, using a higher precision DCT or IDCT in the base layer does not consume significant resources because at such a low bit rate, most of the DCT blocks have zero coefficients after quantization. This prevents drifting (i.e., accumulation of distortion) and thus safeguards the coding quality. Accordingly, the most intensive transform-based computing is left to the enhancement layer, particularly in the case of an SNR-FGS system. Therefore, by reducing the precision of the DCT and/or IDCT in the enhancement layer, computing complexity is reduced without introducing drift, and graceful degradation of quality can be achieved.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A layered video encoding system, comprising:
a base layer encoder for receiving a video signal and outputting a base layer stream; and
an enhancement layer encoder that includes a plurality of discrete cosine transform (DCT) modules and a selection system for selecting one of the DCT modules.

2. The layered video encoding system of claim 1, wherein each of the plurality of DCT modules comprises a different precision.

3. The layered video encoding system of claim 1, wherein the selection system selects one of the DCT modules based on an available level of computing resources.

4. The layered video encoding system of claim 1, wherein the selection system selects one of the DCT modules based on an encoding bit rate.

5. The layered video encoding system of claim 1, wherein the selection system selects one of the DCT modules based on a required quality level.

6. The layered video encoding system of claim 1, wherein the selection system selects one of the DCT modules based on a decoder capability.

7. The layered video encoding system of claim 1, wherein the selection system selects one of the DCT modules based on bandwidth availability.

8. A program product stored on a recordable medium for encoding a layered video signal, the program product comprising:
means for receiving a video signal and outputting an encoded base layer stream; and
means for encoding an enhancement layer, wherein the enhancement layer encoding means includes a plurality of discrete cosine transform (DCT) modules and selection means for selecting one of the DCT modules.

9. The program product of claim 8, wherein each of the plurality of DCT modules comprises a different precision.

10. The program product of claim 8, wherein the selection means selects one of the DCT modules based on one of the group consisting of- an available level of computing resources; an encoding bit rate; a required quality level; a decoder capability; and bandwidth availability.

11. A method of encoding a video signal in a layered manner, comprising:
receiving the video signal in a base layer encoding system;
outputting an encoded base layer stream;
receiving data from the base layer encoding system into an enhancement layer encoding system;
providing a plurality discrete cosine transform (DCT) modules in the enhancement layer encoding system;
selecting one of the plurality of DCT modules; and
generating an encoded enhancement layer stream using the selected DCT module.

12. A layered video decoding system, comprising:
a base layer decoder for receiving and decoding a base layer video stream; and
an enhancement layer decoder for receiving an enhancement layer video stream and generating a decoded enhanced video output, wherein the enhancement layer decoder includes:
a plurality of inverse discrete cosine transform (IDCT) modules; and
a selection system for selecting one of the IDCT modules.

13. The layered video decoding system of claim 12, wherein each of the plurality of IDCT modules comprises a different precision.

14. The layered video decoding system of claim 12, wherein the selection system selects one of the IDCT modules based on an available level of computing resources.

15. The layered video decoding system of claim 12, wherein the selection system selects one of the IDCT modules based on a preferred bit rate.

16. The layered video decoding system of claim 12, wherein the selection system selects one of the IDCT modules based on a required quality level.

17. The layered video decoding system of claim 12, wherein the selection system selects one of the IDCT modules based on a communication bandwidth.

18. A program product stored on a recordable medium for decoding a layered video stream, comprising:
means for receiving and decoding a base layer video stream; and
means for receiving an enhancement layer video stream and generating a decoded enhanced video output, including:
a plurality of inverse discrete cosine transform (IDCT) modules; and
means for selecting one of the IDCT modules.

19. The program product of claim 18, wherein each of the plurality of IDCT modules comprises a different precision.

20. The program product of claim 19, wherein the selection means selects one of the IDCT modules based on one of the group consisting of: an available level of computing resources; an encoding bit rate; and a required quality level; a decoder capability; and bandwidth availability.

21. A method of decoding a layered video stream, comprising:
receiving an encoded base layer stream into a base layer decoder;
decoding the encoded base layer stream and generating a decoded base layer stream;
providing an enhancement layer decoder having a plurality of inverse discrete cosine transform (IDCT) modules;
receiving an encoded enhancement layer stream into the enhancement layer decoder;
selecting one of the plurality of IDCT modules; and
decoding the encoded enhancement layer using the selected IDCT module.
